(19) United States
(12) Patent Application Publication
(10) Pub. No.: US 2026/0255456 A1
(43) Pub. Date: Aug. 27, 2026

(54) A MULTI-CHANNEL LIGHT EMITTING DIODE, LED, DRIVER, AS WELL AS A CORRESPONDING METHOD, LED BASED LIGHTING DEVICE AND A COMPUTER PROGRAM PRODUCT

(71) Applicant: SIGNIFY HOLDING B.V., EINDHOVEN (NL)

(72) Inventors: KARNEKUMAR ARULANDU, BREDA (NL); FRANCISCUS JACOBUS VOSSEN, HELMOND (NL); HAIMIN TAO, EINDHOVEN (NL); HENRICUS MARIUS JOSEPH MARIA KAHLMAN, DONGEN (NL); BEREND JAN WILLEM TER WEEME, EINDHOVEN (NL)

(21) Appl. No.: 19/162,994

(22) PCT Filed: Feb. 21, 2024
(86) PCT No.: PCT/EP2024/054393

§ 371 Date: Sep. 8, 2025

(30) Foreign Application Priority Data
Mar. 10, 2023 (EP) 23161279.7

(51) Int. Cl. H05B 45/46; H05B 45/385

(52) U.S. Cl. CPC H05B 45/46; H05B 45/385

(57) ABSTRACT

A multi-channel Light Emitting Diode, LED, driver, comprising a plurality of LED channels, wherein each of said plurality of LED channels comprises at least one LED for emitting light, and a switch connected in series with said at least one LED for enabling/disabling said at least one LED, and a storage capacitor connected in parallel over said at least one LED and said switch, a Direct Current, DC, power supply arranged for providing DC power to each of said plurality of LED channels, a plurality of charge switches, wherein each of said plurality of charge switches is electrically connected to a respective storage capacitor of a respective LED channel of said plurality of LED channels, wherein each of said plurality of charge switches is arranged for enabling charging, from said provided DC power, said respective storage capacitor, and a controller configured for controlling said plurality of charge switches as a Time Division power demultiplexer such that said DC power is distributed over said storage capacitors of said plurality of LED channels.

### TECHNICAL FIELD

The present disclosure generally relates to the field of lighting and, more specifically, to a multi-channel LED driver for driving multiple LED channels.

### BACKGROUND

Mains powered lighting products may have stringent requirements on Power Factor, PF, and flicker free light output such that a storage element is required to convert a sinusoidal input power into a constant-flicker free light output. For higher power applications e.g., power intake >25 W, legislation has even higher requirements regarding the PF and Total Harmonic Distortion, THD.

To overcome this problem, many LED drivers may have two power stages, i.e. an input stage to ensure a sinusoidal input current, and an output stage for a constant light output. Between the two power stages, there may be provided a storage element in the form of a buffer capacitor.

Such dual state power conversion topologies allow utilization of the buffer capacitor. Yet, an alternative option is to have a first stage with a linear current source as a second stage. Such designs require substantial capacitance at the output in order to minimize power losses as the voltage ripple across the buffer capacitor will be suppressed by the linear current source.

The higher the capacitance, the lower the ripple, the lower the losses. Thereby, the efficiency becomes dependent on the capacitance value. Such single stage power converters can also be used for multiple output channels. An example of such single stage multi-channel LED driver is depicted in FIG. 1, and will be explained later with respect to the figures.

One of the downsides of multi-channel LED based lighting devices is that the channels may have different number of LED's, as well as different types of LEDs. The result is that the sum of the forward voltages may differ for the LED channels. This may create inefficiency as this may promote different voltage headrooms of each of the LED channels. This will be elaborated in more detail later below.

### SUMMARY

It would be advantageous to obtain a multi-channel Light Emitting Diode, LED, driver that is able to efficiently drive multiple channels. It would further be advantageous to obtain a corresponding method, a LED based lighting device, as well as a computer program product.

In a first aspect, there is provided a multi-channel Light Emitting Diode, LED, driver, comprising:
a plurality of LED channels, wherein each of said plurality of LED channels comprises at least one LED for emitting light, and a switch connected in series with said at least one LED for enabling/disabling said at least one LED, and a storage capacitor connected in parallel over said at least one LED and said switch;
a Direct Current, DC, power supply arranged for providing DC power to each of said plurality of LED channels;
a plurality of charge switches, wherein each of said plurality of charge switches is electrically connected to a respective storage capacitor of a respective LED channel of said plurality of LED channels, wherein each of said plurality of charge switches is arranged for enabling charging, from said provided DC power, said respective storage capacitor,
a controller configured for controlling said plurality of charge switches as a power demultiplexer such that said DC power is distributed over said storage capacitors of said plurality of LED channels.

The controller may be configured for controlling the plurality of charge switches as we power demultiplexer such that the DC power is distributed over the storage capacitors of the plurality of LED channels asynchronous from the switching of the DC power supply.

The present disclosure is directed to a multi-channel LED driver for driving a plurality of LED channels, for example at least two LED channels. The LED channels may be heterogeneous, meaning that the LEDs of the corresponding LED channels do not need to be the same. A first LED channel may comprise red colored LEDs, a second LED channel may comprise green colored LEDs, a third LED channel may comprise blue colored LEDs, etc.

Each of the LED channels may have a different sum of forward voltages, due to the fact that different types of LEDs and/or different number of LEDs may be utilized in the LED channels. The LED channels are driven by the same power supply, i.e. the DC power supply, that is arranged to provide DC power to each of the plurality of LED channels.

The headroom voltage may be defined as the voltage provided by the DC power supply minus the sum of the forward voltages of a LED channel. Each LED channel may thus be associated with a particular headroom voltage. A relatively high headroom voltage may be disadvantageous as this may increase the inefficiency of the driver. The headroom voltage may be interpreted as the voltage across the switch in series with the LED channel. An increase in headroom voltage will therefore cause more energy losses in the switch. A relatively low headroom voltage may be advantageous as this may increase the efficiency of the driver.

The inventors have found that it may be beneficial to steer, or control, the voltages over the LEDs of a particular channel in an individual manner. This allows the headroom voltage to be controlled per LED channel. The output of the DC power supply is then not connected, in a time continuous manner, to the LED channels as this would ensure that the voltages over the different LED channels is always the same.

The present disclosure is the opposite, in that the voltages over the different LED channels may be controlled individually thereby controlling the headroom voltage of each of the LED channel individually.

The underlying concept of the present disclosure is that a storage capacitor is connected in parallel to a plurality of LEDs of each channel. The storage capacitor is responsible for providing the voltage over these LEDs. The voltage that is provided by the storage capacitor is controlled, by the controller, in that the controller is configured for controlling the plurality of charge switches as a power demultiplexer such that said DC power is distributed over said storage capacitors of said plurality of LED channels.

The above example allows the storage capacitors to be charged differently from each other, such that different voltages are provided to the different LED's, associated with the different LED channels. One of the benefits is that the headroom voltages can be controlled, thereby improving the efficiency of the corresponding LED driver.

In an example, the controller is further arranged for controlling a total output DC power of said DC power supply.

The controller may have multiple functions. One of the functions is to distribute the total amount of power provided by the DC power supply to the storage capacitors. The distribution ratio may be based on, for example, the respective sum of forward voltages of each of the LED channels. Another function may be to control the total amount of power provided by the DC power supply. The total amount of power that is to be provided by the DC power supply may depend, amongst other, on whether LED channels are turned on or off, and the like.

It is noted that the switch in a particular LED channel, i.e. connected in series with at least one LED for enabling/disabling the at least one LED, may be controlled independently from the corresponding charge switch.

In a further example, the controller is arranged for controlling said plurality of charge switches based on:
a sum of the forward voltages of the at least one LED for a corresponding LED channel; and
an actual voltage over the at least one LED for the corresponding LED channel.

The sum of the forwards voltages of the at least one LED for a corresponding LED channel may be pre-programmed, for example in the controller, or may be measured. The actual voltage over the at least one LED for the corresponding LED channel may be measured, or determined, based on the voltage at the drain terminal, which will be explained later below in more detail.

The decision may thus be based on an actual voltage over the at least one LED and the corresponding linear regulator for the corresponding LED channel.

In a further example, the controller comprises a reference headroom voltage, and wherein said controller is further arranged for:
measuring headroom voltages of the switch in the corresponding LED channels;
determining that a lowest measured headroom voltage is below the reference headroom voltage;
requesting said DC power supply to increase its output DC power.

The voltage over the switch may be measured for determining the headroom voltage. Ideally, the voltage over that switch is relatively low.

In an example, the controller is arranged to steer, or maintain, the lowest measured headroom voltage at the reference headroom voltage, by requesting the DC power supply to increase, or decrease, its output DC power based on the actual lowest measured headroom voltage.

For example, whenever the lowest measured headroom voltage falls below the reference headroom voltage, the controller may request the DC power supply to increase its output DC power. If the lowest measured headroom voltage exceeds the reference headroom voltage, the controller may request the DC power supply to decrease its output DC power. In essence, the controller may use the lowest measured headroom voltage as a parameter for requesting the DC power supply to either increase or decrease its output DC power accordingly.

The controller may thus be arranged to regulate the headroom voltage to a desired level, i.e. to the reference headroom voltage.

The controller may, for example, be an integrated circuit, micro-controller, FPGA, or anything alike, which may act as a linear current regulator for the corresponding LED channels. The headroom voltage may be a feature of the linear current regulator.

In case one of the headroom voltages drops to below a predetermined reference headroom voltage, the controller may step in and request the DC power supply to increase its output power. The controller may not need to amend the way the DC power is distributed over the different storage capacitors, but may—first—request to increase the total amount of DC power of the DC power supply.

In a further example, the controller is arranged for controlling said plurality of charge switches as a Time Division power demultiplexer by ensuring that a next charge switch is enabled before a current charge switch is disabled.

The advantage hereof is that there is always a load connected to the DC power supply, such that undesired phenomena are prevented.

In a further example, the controller is arranged for controlling said plurality of charge switches as a Time Division power demultiplexer such that a sum of duty cycles for controlling said charge switches is at least equal to one.

In another example, the controller is further arranged for:
measuring headroom voltages of the switch in the corresponding LED channels;
determining duty cycles for each of the charge switches based on the measured headroom voltages.

In another example, the DC power supply comprises a galvanic isolated switched mode power supply, SMPS, wherein a secondary side of a transformer comprised by said galvanic isolated SMPS comprises a plurality of separated windings, wherein each of said plurality of separated windings is connected to one of said plurality of LED channels, respectively, for providing said DC power.

The Switched Mode Power Supply may, for example, be a flyback converter or a forward converter.

In yet another example, at least two of said plurality of LED channels are arranged such that a sum of forward voltage of said corresponding at least one LED differ from one another.

In a further example, each of said plurality of LED channels further comprises an unidirectional device such that electrical energy comprised by the storage capacitor of the corresponding LED channel is not able to flow to a different LED channel of said plurality of LED channels.

Preferably, the unidirectional device is a diode or a switch configured to act as a diode, e.g. acting as a synchronous switch. An example of such a switch is a MOSFET, which prevents current to flow into one direction. The current may flow into opposite direction through e.g. the body diode. Upon conduction of the body diode, the MOSFET may be made conductive to lower power losses during the conduction of the MOSFET.

In a second aspect of the present disclosure, there is provided a Light Emitting Diode, LED, based lighting device comprising a multi-channel LED driver in accordance with any of the previous examples.

It is noted that the advantages as explained with reference to the first aspect of the present disclosure, being the multi-channel LED driver are also applicable to the second aspect of the present disclosure, being the LED based lighting device comprising such a multi-channel LED driver.

In a third aspect of the present disclosure, there is provided a method of operating a multi-channel LED driver in accordance with any of the previous examples, wherein said method comprises the steps of:
controlling, by said controller, said plurality of charge switches as a Time Division power demultiplexer such that said DC power is distributed over said storage capacitors of said plurality of LED channels.

In an example, the controller comprises a reference headroom voltage, and wherein said controller is further arranged for:
measuring headroom voltages of the at least one LED in the corresponding LED channels;
determining that a lowest measured headroom voltage is below the reference headroom voltage;
requesting said DC power supply to increase its output DC power.

In a fourth aspect, there is provided a computer program product comprising a computer readable medium having instructions stored thereon which, when executed by a controller of a multi-channel LED driver, cause said controller to implement a method in accordance with any of the previous examples.

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The above and other aspects of the disclosure will be apparent from and elucidated with reference to the examples described hereinafter.

### BRIEF DESCRIPTION OF THE DRAWINGS

FIG. 1 discloses an example of a single stage multi-channel LED driver;

FIG. 2 discloses a first example of a block diagram of a multi-channel LED driver in accordance with the present disclosure;

FIG. 3 discloses a second example of a block diagram of a multi-channel LED driver in accordance with the present disclosure;

FIG. 4 discloses a timing diagram of the multi-channel LED driver zoomed in a specific interval of the mains frequency.

FIG. 5 discloses a timing diagram of the multi-channel LED driver.

### DETAILED DESCRIPTION

It is noted that in the description of the figures, same reference numerals refer to the same or similar components performing a same or essentially similar function.

A more detailed description is made with reference to particular examples, some of which are illustrated in the appended drawings, such that the manner in which the features of the present disclosure may be understood in more detail. It is noted that the drawings only illustrate typical examples and are therefore not to be considered to limit the scope of the subject matter of the claims. The drawings are incorporated for facilitating an understanding of the disclosure and are thus not necessarily drawn to scale. Advantages of the subject matter as claimed will become apparent to those skilled in the art upon reading the description in conjunction with the accompanying drawings.

The ensuing description above provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment of the disclosure, it being understood that various changes may be made in the function and arrangement of elements, including combinations of features from different embodiments, without departing from the scope of the disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, electromagnetic, or a combination thereof. Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

These and other changes can be made to the technology in light of the following detailed description. While the description describes certain examples of the technology, and describes the best mode contemplated, no matter how detailed the description appears, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

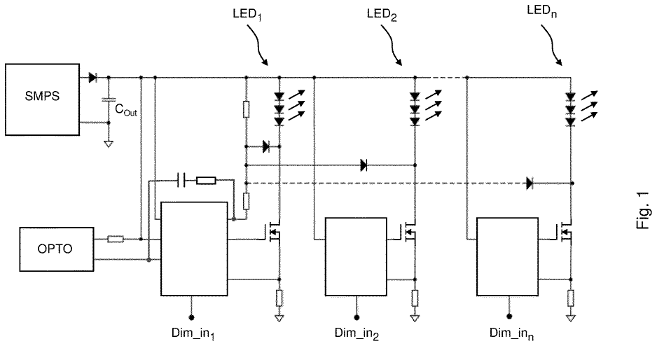

FIG. 1 discloses an example of a single stage multi-channel LED driver.

The output of a high Power Factor, PF, SMPS, switch mode power supply, is connected to a large buffer capacitor Cout, the feedback signal of the SMPS, visualized with the optocoupler, controls the lowest head-room voltage of the linear current sources such that all linear current source have sufficient headroom voltage to control the LED current through the individual LED branches.

By this method, the highest efficiency is achieved on the LED channel with the highest forward voltage, while the efficiency of the other channels is compromised. From efficiency point of view, it is therefore preferable to have equal sting forward voltages in each channel.

Although this topology has its charms in efficiency and cost—as only a single power stage in required—it is known for its limitation of equal string voltages. The present disclosure is directed to a method in which difference in string voltage is allowed, PWM can be applied to multiple LED channels, losses are minimal, and charge/discharge between buffer capacitors of different channels is circumvented.

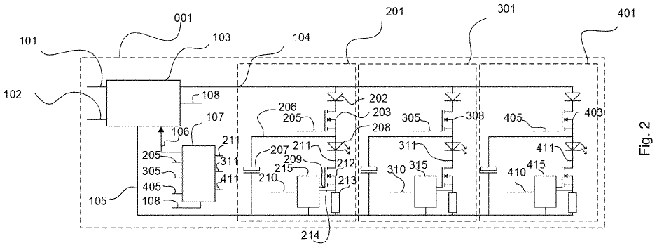

FIG. 2 discloses a first example of a block diagram of a multi-channel LED driver in accordance with the present disclosure.

Mains power is supplied to the SMPS, 001, by line, and neutral terminals 101, and 102, respectively.

Each LED channel 201, 301, 401, up to n01 has an independent current source that has a transistor, 212, a current sense resistor, 213, and a controller 215. Depending on the level of charge across the buffer capacitor 207, and the forward voltage of the LEDs in the corresponding LED channel, the headroom voltages may vary between the different channels.

If the headroom voltage is insufficient, the current regulating transistor may clip and, as a result, the output current will be lower than the set reference level and may even be unregulated. Alternatively, excess headroom voltage across the transistor results in excess power dissipation.

Thus, it is therefore desirable to minimize the headroom voltage without clipping in order to reduce, or minimize, power losses in the current regulating transistors. For equivalent loads, i.e., LED loads with equal forward voltages, the controller 107 may regulate the minimum head room voltage of the channel with the lowest head-room.

The headroom voltage difference between the channels may result into excess dissipation. The controller 107 may determine the ratio of duty-cycles of each individual demultiplexing channel with a sum of duty-cycles to be at least one.

The controller may be a standalone controller or a distributed controller. The controller may be implemented in a micro-controller, in a Field Programmable Gate Array, FPGA, or in an Application Specific Integrated Circuit, ASIC.

Diodes 202 may be provided in each LED channel to prevent electrical charge in a capacitor 207 of a first LED channel to be discharged towards another LED channel, for example the ones indicated with 301 or 401.

In essence, the switch as indicated with reference numeral 212 determines whether a particular LED channel is enabled or not, i.e., activated or not. That switch may also perform dimming aspects, for example by controlling that switch using a Pulse Width Modulation, PWM, control signal. The switches as indicated with reference numerals 203, 303 and 403 are responsible for distributing the power provided by the DC power supply among the corresponding storage capacitors of the respective LED channels 201, 301, 401.

The duty cycles used for controlling these switches determine the distribution of the provided DC power, and thus also to what voltage level the storage capacitors are being charged. As such, the headroom voltage of each of the LED channels may be controlled.

It is noted that it is not mandatory that the storage capacitors are each exactly the same, i.e., having the same storage capacity.

Controller 107 may have two functions: The first function relates to controlling the total output power of SMPS 103. The second function relates to controlling the distribution of the output power of 103 by controlling switches 203, 303, and 403 as a power demultiplexer.

Such arrangement allows the output voltage of SMPS 103 to change instantly depending on the conducting state of the demultiplexer switches. When a lowest headroom voltage is below a particular reference headroom voltage, the controller 107 may increase its feedback signal 106 of the SMPS 103 which in turn increases its output power, and vice versa.

To ensure that a load is always present at the output of 103, a make before break mechanism can be implemented in the demultiplexing controller. Preferably a margin is added to the overlap for the make before break condition where the lower voltage channel is dominant i.e., if two series switches are conducting at the same time, the channel with the lowest forward voltage may receive the most current.

Thus, timing related matters may take this into account to achieve higher accuracy of control that include the make before break mechanism. Control of the series switches may be realized by measuring the individual headroom voltages and normalizing them such that the channel with the highest headroom voltage has the lowest duty-cycle. The duty-cycles can be determined as follows:

$${D}_{203} = \frac{1}{1 + \frac{{V}_{211 , min}}{{V}_{311 , min}} + \frac{{V}_{211 , min}}{{V}_{411 , min}}}$$

$${D}_{303} = \frac{1}{1 + \frac{{V}_{311 , min}}{{V}_{211 , min 1}} + \frac{{V}_{311 , min}}{{V}_{411 , min 3}}}$$

$${D}_{403} = \frac{1}{1 + \frac{{V}_{411 , min}}{{V}_{211 , min}} + \frac{{V}_{411 , min}}{{V}_{311 , min}}}$$

As a result, D₂₀₃+D₃₀₃+D₄₀₃=1.

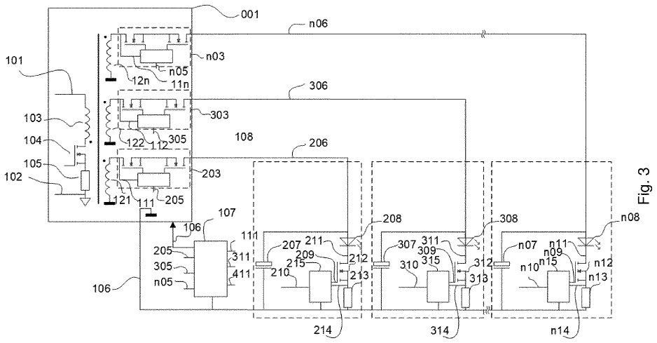

FIG. 3 discloses a second example of a block diagram of a multi-channel LED driver in accordance with the present disclosure. Here the same reference numerals are used with respect to FIG. 2. The difference with respect to the second figure is that multiple secondary windings are used, wherein each secondary winding is connected to a particular LED channel.

The losses in the diodes are then eliminated making use of galvanically isolated secondary windings, and synchronous switches 203, 303, and n03. By galvanically isolating the secondary windings, the timing requirements on the conduction time of the demultiplexing switches are relaxed as an excessive overlap does not result in charge flow between buffer capacitors of different channels.

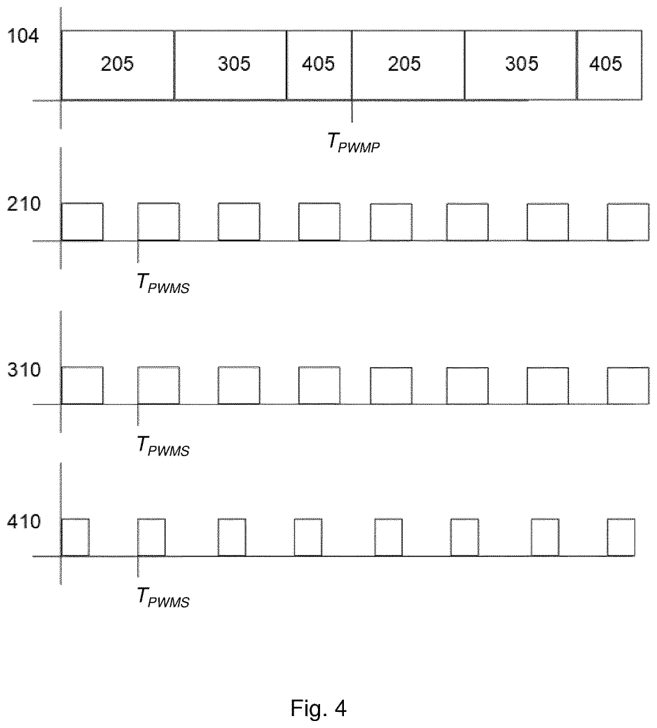

FIG. 4 shows an example of the timing diagram of the multi-channel LED driver with constant input power. As the SMPS 103 does not contain any storage elements, and may need to meet high power factor requirements, the input power and output power may be sinusoidal.

The timing diagram presented in FIG. 4 is zoomed-in at a specific interval where input voltage, current, and power are considered to be constant as the mains frequency is at least an order of magnitude smaller than the operating frequency of the demultiplexing switches.

Hereby, the mains frequency related voltage, current and power variations are neglected as they may be minimal in such short interval. The output power of the SMPS 103 is distributed by the demultiplexer by controller 107 based on the measured individual headroom voltages of the LED channels.

Any arbitrary PWM signal 210, 310, and 410 can be applied to the individual channels, and it does not require any synchronization with respect to the demultiplexer frequency or mains. The set duty-cycles will result in a difference between the channel input power, and channel output power that will result in an increase or decrease of buffer capacitor voltage.

The difference between the capacitor voltage and the LED string forward voltage will be measured as the headroom voltage 211, 311, and 411. Controller 107 may measure all headroom voltages and may take the minimum headroom voltage in order to output the feedback signal, 106, towards the SMPS 103 for either increasing or decreasing the total amount of DC power provided by the SMPS 103.

Since the headroom adjustment may only need to be very slow, usually thermal related effect of LEDs, the control loop for the duty ratio of the power demultiplexing switches, e.g., a few Hz—is much lower than the mains frequency. In this way, the duty ratio may remain constant across a double-line-frequency cycle.

Even though the frequency of the power demultiplexing switches are at least one or two orders in magnitude higher, it can result in undesired intermodulation results i.e., low frequency power variation for constant duty-cycle settings.

The controller 107 may apply compensation for such problems. Besides, the linear current sources that apply the PWM current to the LEDs may filter out these effects. However, intermodulation may cause audible disturbance or disturbance on the input current which can also easily be prevented by synchronizing the power demultiplexing switches with the mains frequency.

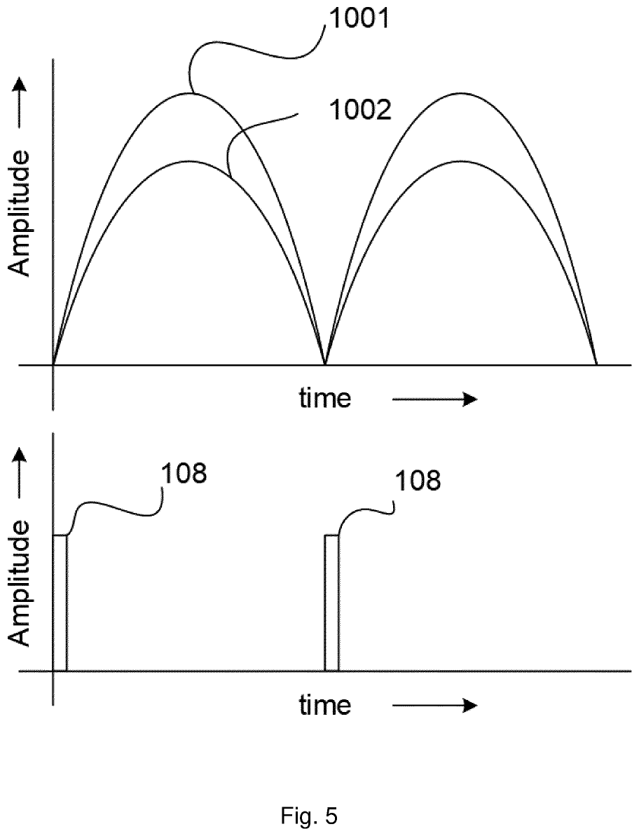

Therefore, the demultiplexing frequency may be a multiple of the mains frequency. FIG. 5 shows the mains input voltage 1001 and input current 1002 as a function of time. A common method of synchronizing to mains frequency is by means of a zero-crossing detector. Near each zero crossing, a zero-crossing signal 1008 may be outputted by the zero-crossing detector to which the controller 107 can synchronize.

In the description above, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope thereof.

1. A multi-channel Light Emitting Diode, LED, driver, comprising:
a plurality of LED channels, wherein each of said plurality of LED channels comprises at least one LED for emitting light, and a switch connected in series with said at least one LED for enabling/disabling said at least one LED, and a storage capacitor connected in parallel over said at least one LED and said switch;
a Direct Current, DC, power supply arranged for providing DC power to each of said plurality of LED channels;
a plurality of charge switches, wherein each of said plurality of charge switches is electrically connected to a respective storage capacitor of a respective LED channel of said plurality of LED channels, wherein each of said plurality of charge switches is arranged for enabling charging, from said provided DC power, said respective storage capacitor,
a controller configured for controlling said plurality of charge switches as a Time Division power demultiplexer such that said DC power is distributed over said storage capacitors of said plurality of LED channels,
wherein said controller is further arranged for:
measuring headroom voltages of the at least one LED in the corresponding LED channels;
determining duty cycles for each of the charge switches based on the measured headroom voltages,
wherein said controller is arranged for controlling said plurality of charge switches as a Time Division power demultiplexer such that a sum of duty cycles for controlling said charge switches is at least equal to one,
determining that a lowest measured headroom voltage of said measured headroom voltages is below the reference headroom voltage; and
requesting said DC power supply to increase its output DC power.

2. A multi-channel LED driver in accordance with claim 1, wherein said controller is further arranged for controlling a total output DC power of said DC power supply.

3. A multi-channel LED driver in accordance with claim 1, wherein said controller is arranged for controlling said plurality of charge switches based on:
a sum of the forward voltages of the at least one LED for a corresponding LED channel; and
an actual voltage over the at least one LED for the corresponding LED channel.

4. A multi-channel LED driver in accordance with claim 1, wherein said controller is arranged for controlling said plurality of charge switches as a Time Division power demultiplexer by ensuring that a next charge switch of said plurality of charge switches is enabled before a current charge switch is disabled.

5. A multi-channel LED driver in accordance with claim 1, wherein said DC power supply comprises a galvanic isolated switched mode power supply, SMPS, wherein a secondary side of a transformer comprised by said galvanic isolated SMPS comprises a plurality of separated windings, wherein each of said plurality of separated windings is connected to one of said plurality of LED channels, respectively, for providing said DC power.

6. A multi-channel LED driver in accordance with claim 5, wherein said SMPS is a flyback converter.

7. A multi-channel LED driver in accordance with claim 1, wherein at least two of said plurality of LED channels are arranged such that a sum of forward voltage of said corresponding at least one LED differ from one another.

8. A multi-channel LED driver in accordance with claim 1, wherein each of said plurality of LED channels further comprises a rectifier such that electrical energy comprise by the storage capacitor of the corresponding LED channel is not able to flow to a different LED channel of said plurality of LED channels.

9. A Light Emitting Diode, LED, based lighting device comprising a multi-channel LED driver in accordance with claim 1.

10. A method of operating a multi-channel Light Emitting Diode, LED, driver, the multi-channel LED driver, comprising:
a plurality of LED channels, wherein each of said plurality of LED channels comprises at least one LED for emitting light, and a switch connected in series with said at least one LED for enabling/disabling said at least one LED, and a storage capacitor connected in parallel over said at least one LED and said switch;
a Direct Current, DC, power supply arranged for providing DC power to each of said plurality of LED channels;
a plurality of charge switches, wherein each of said plurality of charge switches is electrically connected to a respective storage capacitor of a respective LED channel of said plurality of LED channels, wherein each of said plurality of charge switches is arranged for enabling charging, from said provided DC power, said respective storage capacitor,
a controller configured for controlling said plurality of charge switches as a Time Division power demultiplexer such that said DC power is distributed over said storage capacitors of said plurality of LED channels,
wherein said controller is further arranged for:
measuring headroom voltages of the at least one LED in the corresponding LED channels;
determining duty cycles for each of the charge switches based on the measured headroom voltages,
wherein said controller is arranged for controlling said plurality of charge switches as a Time Division power demultiplexer such that a sum of duty cycles for controlling said charge switches is at least equal to one,
determining that a lowest measured headroom voltage of said measured headroom voltages is below the reference headroom voltage; and
requesting said DC power supply to increase its output DC power, wherein the method comprises:
controlling, by said controller, said plurality of charge switches as a Time Division power demultiplexer such that said DC power is distributed over said storage capacitors of said plurality of LED channels.

11. A method in accordance with claim 10, wherein said controller comprises a reference headroom voltage, and wherein said controller is further arranged for:
measuring headroom voltages of the at least one LED in the corresponding LED channels;
determining that a lowest measured headroom voltage is below the reference headroom voltage;
requesting said DC power supply to increase its output DC power.

12. A non-transitory computer readable medium comprising instructions stored thereon which, when executed by a controller of a multi-channel LED driver, cause said controller to perform the method of claim 10.
